(19) United States
(12) Patent Application Publication
(10) Pub. No.: US 2010/0032070 A1
(43) Pub. Date: Feb. 11, 2010

(54) Tire with a Self-Sealing Ply

(75) Inventors: Loïc Albert, Clermont-Ferrand (FR); José Merino Lopez, Riom (FR); Lucien Sylvain, Clermont-Ferrand (FR); Michel Ahouanto, Enval (FR); Pierre Lesage, Clermont-Ferrand (FR)

Correspondence Address: COHEN, PONTANI, LIEBERMAN & PAVANE LLP, 551 FIFTH AVENUE, SUITE 1210, NEW YORK, NY, 10176, US

(73) Assignee: Michelin Recherche et Technique S.A., Granges-Paccot (CH)

(21) Appl. No.: 12/520,435

(22) PCT Filed: Dec. 19, 2007
(86) PCT No.: PCT/EP2007/011153

§ 371 Date: Aug. 11, 2009

(51) Int. Cl. B60C 19/12

(52) U.S. Cl. 152/504

(57) ABSTRACT

Tire comprising at least two sidewalls, a crown provided radially externally with a tread, a carcass-type reinforcing structure and a crown reinforcement, the inner surface of the sidewalls and of the crown forming an inner wall of the tire, at least one portion of said wall being covered with a self-sealing layer comprising a thermoplastic stirene (TPS) elastomer and the tire being able to be inflated to a given service inflation pressure Pᵢ. For any temperature within a given temperature range, between +30° C. and +100° C., the self-sealing layer has a loss factor tan δ of less than 0.2 and a dynamic modulus G* of less than Pᵢ, tan δ and G* being measured at a frequency of 10 Hz.

### FIELD OF THE INVENTION

The present invention relates to a tire that includes a self-sealing layer placed on its inner wall in order to close off any holes due to perforations in service.

### TECHNOLOGICAL BACKGROUND

To be usable, a self-sealing layer must meet many conditions of a physical and chemical nature. In particular, it must be effective over a very wide range of operating temperatures and to do so over the entire lifetime of the tire. It must be capable of closing off holes when the responsible puncturing object, which we call a “nail”, remains in place. Upon expelling the nail, the self-sealing layer must be able to fill up the hole and make the tire airtight, especially under winter conditions.

Many solutions have been imagined but have not been able to be developed for passenger vehicle tires, in particular for lack of stability over time or lack of effectiveness under extreme operating temperature conditions.

To help to maintain fuel efficiency at high temperature, document U.S. Pat. No. 4,113,799 provides a self-sealing layer based on a combination of butyl rubbers of high and low molecular weight that are partially crosslinked, possibly in the presence of a small fraction of a thermoplastic styrene elastomer. For good sealing effectiveness, the self-sealing layers proposed in that document also have an extension elastic modulus of preferably between 0.035 and 0.063 MPa.

U.S. Pat. No. 4,426,468 has self-sealing layers for the tire which are based on a butyl rubber or high molecular weight, which is crosslinked, and the formulation of which is adjusted so as to meet values given for the stress at break, elongation at break and crosslinking density characteristics.

These coatings degrade the tires in terms of rolling resistance. They may be insufficiently effective, in particular after expulsion of a nail that has remained in place for an appreciable period of time in the structure of the tire and/or under winter temperature conditions.

Document EP 1 090 069 B1 discloses a self-sealing composition with 100 parts by weight of a styrene-based thermoplastic elastomer, 110 to 190 parts by weight of an adhesive, 80 to 140 parts by weight of a liquid plasticizer and 2 to 20 parts by weight of an additive. That document therefore provides no information about the physical characteristics of the compositions, which are also liable to degrade the rolling resistance of tires comprising them.

### DESCRIPTION OF THE INVENTION

The subject of the invention is a tire comprising at least two sidewalls, a crown provided radially externally with a tread, a carcass-type reinforcing structure and a crown reinforcement, the inner surface of the sidewalls and of the crown forming an inner wall of the tire, at least one portion of the inner wall being covered with a self-sealing layer comprising a thermoplastic styrene (TPS) elastomer and the tire being able to be inflated to a given service inflation pressure Pᵢ. This tire is characterized in that, for any temperature within a given temperature range, between +30° C. and +100° C., the self-sealing layer has a loss factor tan δ of less than 0.2 and a dynamic modulus G* of less than Pᵢ, tan δ and G* being measured at a frequency of 10 Hz.

The self-sealing elastomer layer of the tire according to the invention has the advantage of behaving mechanically in an almost purely elastic manner over a very wide range of tire operating temperatures. This behaviour virtually eliminates any degradation in terms of rolling resistance compared with a tire that does not include such a covering and substantially improves the rate of sealing when a nail that has remained in place in the structure of the tire for an appreciable time is removed. The expression “an appreciable time” is understood to mean from a few hours to a few days.

It has also been found that when the dynamic modulus G* becomes greater than the inflation pressure Pᵢ within the given temperature range, the sealing properties of the self-sealing layer deteriorate. This is because since the driving force of several sealing mechanisms are the compressive forces due to the tire inflation pressure, when the dynamic modulus G* of a self-sealing layer is equal to or greater than the inflation pressure Pᵢ it has been found that the self-sealing layer is no longer deformable enough for effectively closing off the holes due to punctures, especially after the puncturing object has been expelled. However, certain self-sealing layers that are too rigid for passenger vehicle tires with a service pressure between 2 and 3 bar may be used successfully for heavy-goods vehicle tires with a service pressure of around 8 to 10 bar.

Preferably, the loss factor tan δ is continuously less than 0.15.

This means that there is no degradation in rolling resistance and ensures that punctures are effectively closed off by the covering.

The dynamic modulus G* is also preferably greater than Pᵢ/30. This value, combined with the very low value of the loss factor, ensures that there is excellent form stability during rolling at high speed and at high temperature.

The Applicants have also found that a preferential range for the dynamic modulus G* is:

0.01<G*<0.1 MPa

and a self-sealing layer having a dynamic modulus within this range may be used effectively in many types of tire.

Advantageously, the given temperature range extend through the low-temperature range [+10; +30]° C. so as to take into account use of the tire in cold conditions. The given temperature range is then from +10 to +100° C.

Advantageously, this range may include the high-temperature range [100; 130]° C. so as to ensure good behaviour and especially good dimensional stability at high temperatures. The given temperature range is then from +10 to +130° C.

Preferably, the TPS is the predominant elastomer of the self-sealing layer.

The thermoplastic styrene elastomer is preferably chosen from the group of styrene/butadiene/styrene (SBS), styrene/isoprene/styrene (SIS), styrene/isoprene/butadiene/styrene (SIBS), styrene/ethylene-butylene/styrene (SEBS), styrene/ethylene-propylene/styrene (SEPS) and styrene/ethylene-ethylene-propylene/styrene (SEEPS) block copolymers and blends of these copolymers.

The tire according to the invention advantageously includes a self-sealing layer with a minimum thickness of 0.3 mm and preferably of between 0.5 and 10 mm. The thickness of this layer is considerably dependent on the type of tire in question. For a heavy-goods or agricultural vehicle, this thickness may be between 1 and 3 mm. For civil engineering vehicle tires, the thickness may be between 2 and 10 mm. Finally, for passenger vehicles this thickness may be between 0.4 and 2 mm.

The elongation at break ε_{B} of the self-sealing layer is preferably greater than 500% and even greater than 800%. The stress at break σ_{B} is preferably greater than 0.2 MPa.

Another subject of the invention is a tire that includes an airtight layer having a rubber composition substantially impermeable to the inflation gas and substantially covering the entire inner wall of the tire, in which the self-sealing layer covers, at least partly, the airtight layer on the side facing the internal cavity of the tire.

In another embodiment of a tire according to the invention, the self-sealing layer may be placed between an airtight layer and the carcass-type reinforcement.

In the tires according to the invention, the self-sealing layer may be placed at the crown of said tires, and this layer may extend as far as the equators, or from one sidewall to the other, at least up to a radial position corresponding approximately to the edge of the rim flange when the tire is in the fitted position. The extent of the self-sealing layer depends on the risk of puncture of the tires in question, but also on the compromise between these risks and the weight of these tires.

### BRIEF DESCRIPTION OF THE DRAWINGS

All the embodiment details are given in the following description, which is supplemented by FIGS. 1 to 5 in which:

FIG. 1 shows schematically a radial cross section of a tire incorporating a self-sealing layer according to the invention;

FIG. 2 illustrates schematically a radial cross section of a second embodiment of a tire according to the invention;

FIGS. 3 and 4 show schematically the sealing mechanisms of the self-sealing layers according to the invention in the presence of a puncturing object and after its removal; and

FIG. 5 shows results of the dynamic mechanical characterization of the constituent materials of the self-sealing layers according to the invention.

### DETAILED DESCRIPTION OF THE INVENTION

The dynamic properties of the elastomer materials are obtained on an MCR 301 reometer from the company Anton Paar. The specimens are cylindrical with a thickness of 2.5 mm and a diameter of 4 mm. These specimens are placed in a thermal chamber between two flat plates, one being fixed and the other oscillating sinusoidally about its centre, and a normal stress of 0.02 MPa is also applied throughout the duration of the tests. A maximum deformation of 1% is imposed and a temperature scan from −100° C. to 250° C. is carried out with a ramp of 5° C./mn. The results exploited are the dynamic shear modulus G* and the loss factor tan δ within the given temperature range, where:

G*=\sqrt{G′²+G″²} and tan δ=G″/G′

G*: dynamic shear modulus in MPa;

G′: real shear modulus in MPa;

G″: loss modulus in MPa; and

δ: phase shift between the imposed deformation and the measured stress.

The extension modulus of a material is understood to mean the apparent secant extension modulus obtained for a given uniaxial extension deformation ε, at first elongation (i.e. without an accommodating cycle), measured at 23° C.; the pull rate is 500 mm.min⁻¹ (ASTM D412 standard). This modulus is called the modulus E.

$$E = \frac{σ}{ɛ} = \frac{F}{{S}_{0} ɛ} ;$$

where S₀ is the initial cross section of the test piece, F is the extension force measured at the deformation in question and σ=F/S₀ is the extension stress at the deformation in question.

The terms σ_{B} and ε_{B} are understood to mean the measured stress and elongation at break of the test pieces of material (σ_{B} being normalized to the initial cross section S₀ of the test piece).

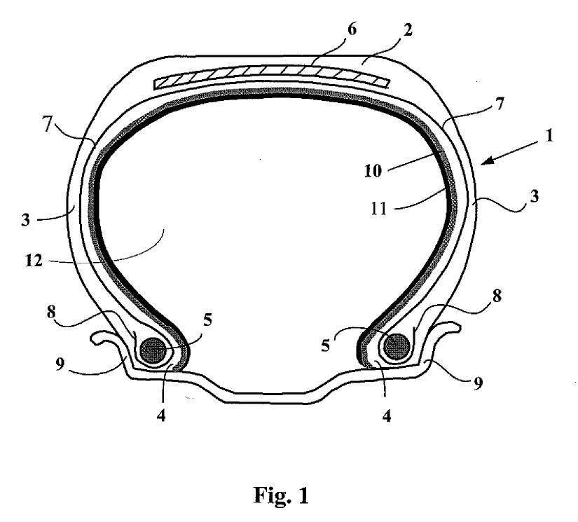

FIG. 1 shows schematically a radial cross section of a tire incorporating a self-sealing layer according to the invention.

This tire 1 has a crown 2 reinforced by a crown reinforcement or belt 6, two side walls 3 and two beads 4, each of these beads 4 being reinforced with a bead wire 5. The crown 2 is surmounted by a tread (not shown in this schematic figure). A carcass reinforcement 7 is wound around the two bead wires 5 in each bead 4, the upturn 8 of this reinforcement 7 lying for example towards the outside of the tire 1, which here is shown fitted onto its rim 9. The carcass reinforcement 7 consists, as is known per se, of at least one ply reinforced by cords, called “radial” cords, for example textile or metal cords, i.e. these cords are arranged practically parallel to one another and extend from one bead to the other so as to form an angle of between 80° and 90° with the circumferential mid-plane (the plane perpendicular to the rotation axis of the tire, which is located at mid-distance of the two beads 4 and passes through the middle of the crown reinforcement 6). An airtight layer 10 extends from one bead to the other radially to the inside relative to the carcass reinforcement 7.

The tire 1 is characterized in that its inner wall includes a self-sealing layer 11. In accordance with a preferred embodiment of the invention, the self-sealing layer 11 covers the entire airtight layer 10 and constitutes substantially the entire inner wall of the tire. The self-sealing layer may also extend from one sidewall to the other, at least from a radial height corresponding to the ends of the rim gutters when the tire is in the fitted position. According to other possible embodiments, the self-sealing layer 11 could cover only a portion of the airtight zone (layer 10), for example only the crown zone of the tire, or could extend at least from the crown zone to mid-points of the sidewalls (the equators) of the tire.

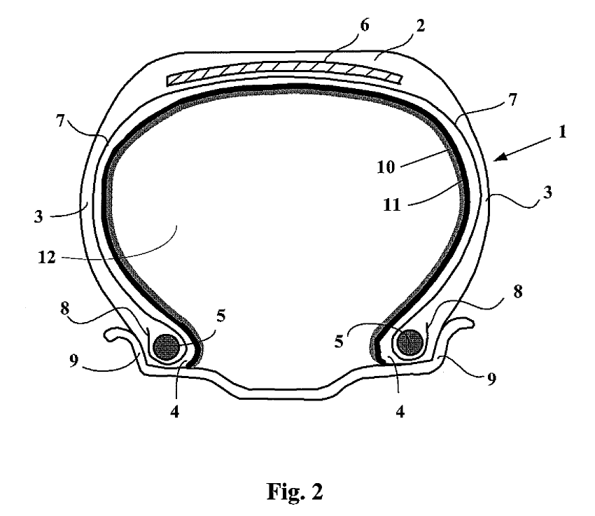

According to another preferred embodiment, illustrated in FIG. 2, the self-sealing layer 11 is placed between the carcass reinforcement 7 and the airtight layer 10. In other words, the airtight layer 10 covers the self-sealing layer 11 on the side facing the internal cavity of the tire 1.

The airtight layer (with a thickness of 0.7 to 0.8 mm) is based on butyl rubber having a conventional formulation for an inner liner, which usually defines, in a conventional tire, the radially internal face of said tire intended to protect the carcass reinforcement from diffusion of air coming from the internal space of the tire. This airtight layer 10 therefore enables the tire 1 to be inflated and kept under pressure. Its sealing properties enable it to guarantee a relatively low rate of pressure drop, making it possible to keep the tire inflated, in the normal operating state, for a sufficient time, normally several weeks or several months.

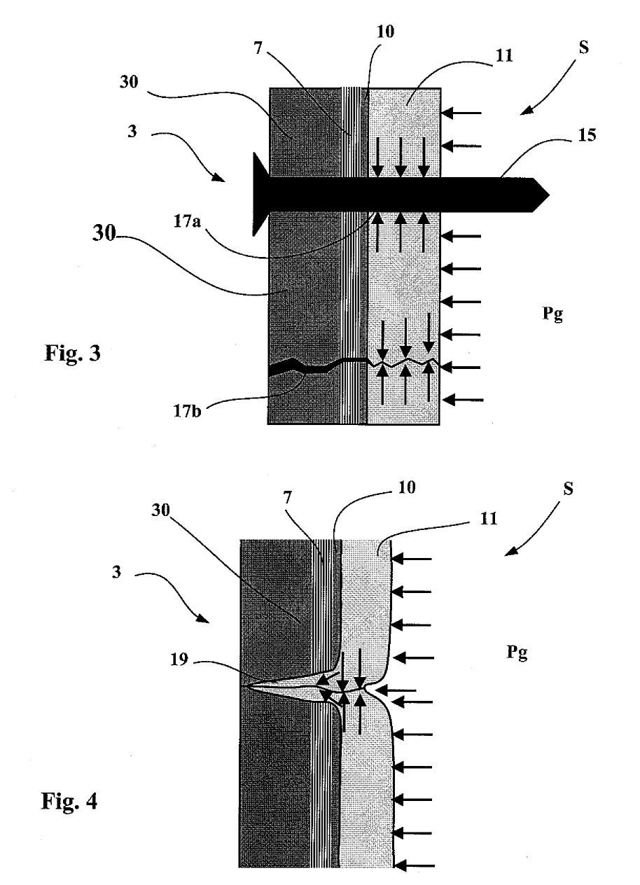

FIGS. 3 and 4 illustrate highly schematically the sealing mechanisms of the self-sealing layers according to the invention in the presence of a puncturing object and after its removal. These two figures show an enlarged part of a portion S of a sidewall 3 of the tire 1.

In FIG. 3, a puncturing object 15 has passed completely through the sidewall 3 of the tire, creating the crack 17a. The puncturing object or nail remains in place and the arrows indicate the direction of the stresses created by the inflation pressure Pᵢ in the internal cavity 12 of the tire 1. This inflation pressure Pᵢ places the self-sealing layer in a state of hydrostatic compression which is more perfect the lower its elastic extension modulus or its dynamic shear modulus. These forces apply the material of the self-sealing layer against the puncturing object 15 and seat off the crack 17a.

The same FIG. 3 shows the crack 17b after removal of the nail 15 when the two lips of the crack in the material 30 of the sidewall 3 and the other layers of materials are very close together. Likewise, the same hydrostatic compressive forces ensure closure of the lips of the crack 17b in the self-sealing layer and thus seal off this crack 17b.

It should be noted that when the nail remains in place, the airtight layer 11 enables the leak rate through the crack 17a to be very greatly limited. However, when the nail is removed, this airtight layer is absolutely incapable of sealing off the crack 17b and the tire goes flat often virtually instantaneously.

FIG. 4 shows the case in which, after the puncturing object has been removed, the lips of the crack created in the structure of the tire sidewall 3 are moved substantially apart and leave a true hole of finite dimension. Such a hole may commonly have a diameter of several mm. In this case, the driving force for sealing off such a crack 17b is again the hydrostatic pressure generated in the self-sealing layer by the inflation pressure Pᵢ. These forces result in a displacement in the crack so as to fill the material of the self-sealing layer close to the crack. This results in excellent sealing of the crack.

This displacement is easier the lower the dynamic modulus of the material of the self-sealing layer. In any case, this modulus must be less than the inflation pressure so that cracks of appreciable diameter can be sealed off. This dynamic modulus must not be too low so as to prevent the material of the self-sealing layer from passing through the crack. These displacements thus require the materials of the self-sealing layer to have a high elongation at break combined with a high stress at break so as to be able to fill the cracks without breaking. An elongation at break of greater than 500% and preferably greater than 800% combined with a stress at break greater than 0.2 MPa in the case of the materials according to the invention are satisfactory.

The self-sealing layers according to the invention behave mechanically in a very similar way to an elastic material. This behaviour gives them a substantial advantage over the usual self-sealing layers with a much more viscous mechanical behaviour. This advantage is demonstrated when a puncturing object is removed, especially when this puncturing object has remained in place for several hours or even several days and even longer. In such a case, the material of the usual self-sealing layer largely had time to completely relax all around the puncturing object, and its viscosity opposes the hydrostatic compressive forces that tend to make the material flow into the crack created by the removal. This may result, especially if its adhesion to the puncturing object has decreased, in a lack of sealing for a relatively long time. This lack of sealing is very readily audible when the puncturing object is removed.

In contrast, the self-sealing layers according to the invention behave in a practically purely elastic manner, and during removal, through the action of the hydrostatic compressive forces, the response is virtually instantaneous. This sealing defect is no longer observed.

The styrene thermoplastic (TPS) elastomers are thermoplastic elastomers in the form of styrene-based block copolymers.

Having a structure intermediate between thermoplastic polymers and elastomers, they consist, as is known, of hard polystyrene blocks linked by soft elastomer blocks, for example polybutadiene, polyisoprene or poly(ethylene-butylene) blocks. TPS elastomers are often triblock elastomers with two hard segments linked by a soft segment. The hard and soft segments may be in a linear, star or branched configuration.

Preferably, the self-sealing layer according to the invention comprises a TPS elastomer chosen from the group of styrene/butadiene/styrene (SBS), styrene/isoprene/styrene (SIS), styrene/isoprene/butadiene/styrene (SIBS), styrene/ethylene-butylene/styrene (SEBS), styrene/ethylene-propylene/styrene (SEPS) and styrene/ethylene-ethylene-propylene/styrene (SEEPS) block copolymers and blends of these copolymers.

More preferably, said elastomer is chosen from the group consisting of SEBS copolymers, SEPS copolymers and a blend of these copolymers.

According to another preferred embodiment of the invention, the styrene content in the TPS elastomer is between 5 and 50%.

Below the indicated minimum, the thermoplastic nature of the elastomer runs the risk of being substantially reduced, whereas above the recommended maximum the elasticity of the composition may be adversely affected. For these reasons, the styrene content is more preferably between 10 and 40%, in particular between 15 and 35%.

It is preferable for the glass transition temperature (T_{g}, measured according to ASTM D3418) of the TPS elastomer to be below −20° C., more preferably below −40° C.

A T_{g} above these minimum temperatures, meaning a higher T_{g} of the self-sealing composition itself, may reduce the performance of the self-sealing composition when used at very low temperature. For such use, the T_{g} of the TPS elastomer is preferably even below −50° C.

The number-average molecular weight (denoted by Mₙ) of the TPS elastomer is preferably between 50 000 and 500 000 g/mol, more preferably between 75 000 and 450 000 g/mol. Below the minimum values indicated, the cohesion between the TPS elastomer chains, because of its dilution (amount of extender), runs the risk of being degraded. Moreover, an increase in the usage temperature runs the risk of adversely affecting the mechanical properties, especially the properties at break, consequently leading to reduced “hot” performance. Moreover, too high a molecular weight Mₙ may be detrimental as regards the flexibility of the composition at the recommended extender oil contents. Thus, it has been found that a value lying within the 250 000 to 400 000 range is particularly suitable, especially for use of the self-sealing composition in a tire.

The number-average molecular weight (Mₙ) of the TPS elastomer is determined, in a known manner, by SEC (steric exclusion chromatography). The specimen is firstly dissolved in tetrahydrofuran with a concentration of about 1 g/l and then the solution is filtered on a filter of 0.45 μm porosity before injection. The apparatus used is a WATERS Alliance chromatograph. The elution solvent is tetrahydrofuran, the flow rate is 0.7 ml/min, the temperature of the system is 35° C. and the analysis time is 90 min. A set of four WATERS columns in series, namely a STYRAGEL HMW7 column, a STYRAGEL HMW6E column and two STYRAGEL HT6E columns, are used. The injected volume of the polymer specimen solution is 100 μl. The detector is a WATERS 2410 differential refractometer and its associated software for handling the chromatograph data is the WATERS MILLENIUM system. The calculated average molecular weights are relative to a calibration curve obtained with polystyrene standards.

The TPS elastomer may constitute all of the elastomer matrix or the predominant portion by weight (of preferably more than 50% and even more preferably more than 70%) of the matrix when it includes one or more other elastomers, whether thermoplastic or not, for example elastomers of the diene type.

According to a preferred embodiment, the TPS elastomer is the sole elastomer and the sole thermoplastic elastomer present in the self-sealing composition.

To obtain dynamic moduli in accordance with the invention, the self-sealing layers preferably include extender oils (or plasticizing oils) used in a very high amount, of between 200 and 700 phe (i.e. between 200 and 700 parts per hundred parts of elastomer by weight).

Any extender oil may be used, preferably one having a weakly polar character, capable of extending or plasticizing elastomers, especially thermoplastic elastomers.

At ambient temperature (23° C.), these oils, which are relatively viscous, are liquids (i.e. as a reminder, substances having the capability of eventually taking the form of their container), as opposed especially to resins, particularly to tackifying resins, which are by nature solids.

Preferably, the extender oil is chosen from the group formed by polyolefin oils (i.e. those resulting from the polymerization of olefins, monoolefins or diolefins), paraffinic oils, naphthenic oils (of low or high viscosity), aromatic oils, mineral oils and mixtures of these oils.

More preferably, a polyisobutene, especially polyisobutylene (PIB), oil, a paraffinic coil or a mixture of these oils is used.

Examples of polyisobutylene oils include those sold in particular by Univar under the trade name “Dynapak Poly” (e.g. “Dynapak Poly 190”), by BASF under the trade name “Glissopal” (e.g. “Glissopal 1000”) or “Oppanol” (e.g. “Oppanol B12”); paraffinic oils are sold for example by Exxon under the brand name “Telura 618” or by Repsol under the brand name “Extensol 51”.

The number-average molecular weight (Mₙ) of the extender oil is preferably between 200 and 30 000 g/mol, more preferably still between 300 and 10 000 g/mol.

For excessively low Mₙ values, there is a risk of the oil migrating to the outside of the self-sealing composition, whereas excessively high Mₙ values may result in this composition becoming too stiff. An Mₙ value between 400 and 3000 g/mol proves to be an excellent compromise for the intended applications, in particular for use in a tire.

The number-average molecular weight (Mₙ) of the extender oil is determined, in a known manner, by SEC. The specimen is firstly dissolved in tetrahydrofuran with a concentration of about 1 g/l and then the solution is filtered on a filter of 0.45 μm porosity before injection. The apparatus used is a WATERS Alliance chromatograph. The elution solvent is tetrahydrofuran, the flow rate is 1 ml/min, the temperature of the system is 35° C. and the analysis time is 30 min. A set of two WATERS columns in series, namely two STYRAGEL HT6E columns, are used. The injected volume of the polymer specimen solution is 100 μl. The detector is a WATERS 2410 differential refractometer and its associated software for handling the chromatograph data is the WATERS MILLENIUM system. The calculated average molecular weights are relative to a calibration curve obtained with polystyrene standards.

A person skilled in the art will know, in the light of the description and the embodiments that follow, how to adjust the quantity of extender oil according to the particular usage conditions of the self-sealing layer, in particular on the type of tire in which it is intended to be used.

It is preferable for the extender oil content to be between 250 and 600 phe. Below the indicated minimum, the self-sealing composition runs the risk of having too high a rigidity for certain applications, whereas above the recommended maximum there is a risk of the composition having insufficient cohesion. For this reason, the extender oil content is more preferably between 300 and 500 phe, especially for use of the self-sealing composition in a tire.

TPS elastomers such as SEPS or SEBS extended with high oil levels are well known and commercially available. As examples, mention may be made of the products sold by Vita Thermoplastic Elastomers or VTC (VTC TPE group) under the name “Dryflex” (e.g. “Dryflex 967100”) or “Mediprene” (e.g. “Mediprene 500 000M”) and those sold by Multibase under the name “Multiflex” (e.g. “Multiflex G00”).

These products, developed in particular for medical, pharmaceutical or cosmetic applications, may be conventionally processed for TPEs, by extrusion or moulding, for example starting with a raw material available in bead or granule form.

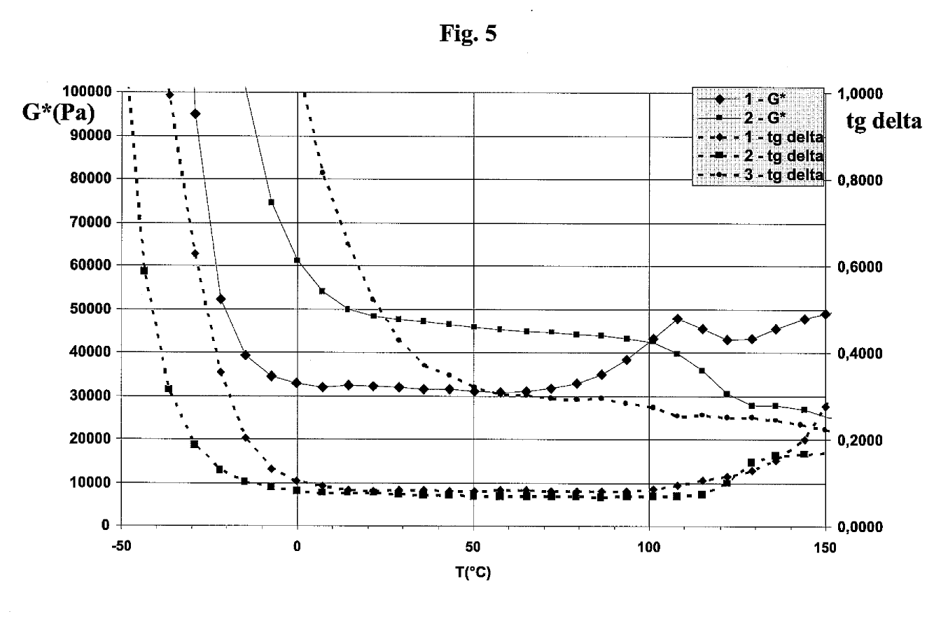

FIG. 5 shows the dynamic properties of three materials, two of which are in accordance with the invention. Material 1 is the commercial product “Mediprene 500 000 M” and material 2 is the commercial product “Multiflex G00”. These two materials have a paraffinic extender oil content of around 400 phe by weight. Material 3 is a mixture normally used as airtight layer. It is based on a butyl elastomer.

Plotted in FIG. 5 on the x-axis is the measurement temperature between −50° C. and +150° C. and plotted on the left-hand y-axis is the dynamic shear modulus G* expressed with a linear scale in Pa and plotted on the right-hand y-axis is the loss factor tan δ. The curves representing G* as a function of temperature are with solid lines and those representing tan δ are the dotted lines. To make observation easier, the G* scale is limited to the preferred maximum G*=100 000 Pa (or 1 bar) and the tan δ scale is limited to 1.

Materials 1 and 2 have their tan δ values less than 0.15 over the entire temperature range [0; 130° C.]. Their behaviour is thus purely elastic over this entire temperature range, and the rolling resistance of tires including this self-sealing layer was measured and confirmed the absence of any degradation due to the presence of this self-sealing layer. As a reminder, the degradation in rolling resistance of a tire that includes a standard self-sealing covering may be up to 5%.

The dynamic shear modulus of these two materials is between 30 000 and 60 000 Pa within the same temperature range. These dynamic shear modulus values give the materials very great flexibility, this being highly favourable in respect of the mechanisms for closing off cracks and holes in the case of passenger vehicles with an inflation pressure of the order of 1 to 3 bar.

For comparison, material 3 has a tan δ value always greater than 0.2 within the entire temperature range in question. A layer of such a material results in an appreciable degradation in rolling resistance, this being more considerable when the dynamic shear is modulus is itself very high, of the order of 1 MPa within the temperature range in question.

It should be noted that the tan δ curve of this third material increases very substantially when the temperature drops below 50° C., which means that the degradation in rolling resistance will be more substantial under winter conditions, but also that the associated increase in dynamic shear modulus will lead to a degradation in the crack-sealing behaviour at low temperature. It is a significant advantage of the materials according to the invention to have a stable crack-sealing behaviour within a very wide range of temperatures, especially at low temperatures.

At high temperature, the fact that the reserved tan δ increases are substantially only above 100° C. is very positive, guaranteeing good dimensional stability of the self-sealing layers in the tire, especially when rolling at high speed.

Materials 1 and 2 both have an elongation at break greater than 1000% and a stress at break greater than 0.2 MPa.

The tires shown in FIGS. 1 and 2, which are provided with their self-sealing layers 11 as described above, may be produced before vulcanization or afterwards.

In the first case (i.e. before vulcanization of the tire), the self-sealing composition is simply applied in a conventional manner at the desired place, so as to form the layer 11. The vulcanization is then carried out conventionally. The TPS elastomers are well able to withstand the stresses due to the vulcanization step.

An advantageous manufacturing variant, for a person skilled in the art, would consist for example in laying down the self-sealing layer flat, directly on a building drum, in the form of a skim with a suitable thickness (for example 3 mm), before this is covered with the airtight layer followed by the rest of the structure of the tire. This type of process also makes it possible for the second embodiment, shown in FIG. 2, to be easily produced in which the sealing layer 10 constitutes the inner wall of the tire in contact with the inflation air.

In the second case (i.e. after vulcanization of the tire), the self-sealing layer is applied to the inside of the cured tire by any appropriate means, for example by bonding, by spraying or by extrusion-blow moulding a film of suitable thickness.

During trials, passenger car tires, of 205/55 R16 “Energy 3” size were tested. The inner wall of the tires (already including the air-airtight layer 12) was covered with the self-sealing layer 11 described above (“Mediprene 500 000M”), with a thickness of 2 mm, and then the tires were vulcanized.

Five perforations 6 mm in diameter and two perforations 1 mm in diameter were produced, on one of the tires when fitted and inflated, through the tread and the crown block on the one hand, and on the sidewalls on the other, using punches that were immediately removed. The tire was then run in a flywheel rolling test, with a nominal load, at 130 km/h for 6 300 km without loss of pressure.

The same perforations were produced on a second tire, when mounted and inflated, and the puncturing objects were left in place for one week. The tire was then run in a flywheel rolling test under a nominal load at 130 km/h for 6 300 km, again without appreciable loss of pressure.

The invention is not limited to the examples described and shown, and various modifications may be applied thereto without departing from its scope defined by the appended claims.

1. A tire comprising at least two sidewalls, a crown provided radially externally with a tread, a carcass-type reinforcing structure and a crown reinforcement, the inner surface of the sidewalls and of the crown forming an inner wall of the tire, at least one portion of said wall being covered with a self-sealing layer comprising a thermoplastic stirene (TPS) elastomer and the tire being adapted to be inflated to a given service inflation pressure Pᵢ, wherein, for any temperature within a given temperature range, between +30° C. and +100° C., the self-sealing layer has a loss factor tan of less than 0.2 and a dynamic modulus G* of less than Pᵢ, tan and G* being measured at a frequency of 10 Hz.

2. The tire according to claim 1, wherein the self-sealing layer has, for any temperature within the given temperature range, a loss factor tan of less than 0.15.

3. The tire as claimed in claim 1, wherein the self-sealing layer has, for any temperature within the given temperature range, a dynamic modulus G* of greater than Pᵢ/30.

4. The tire as claimed in claim 1, wherein the self-sealing layer has, for any temperature within the given temperature range, a dynamic modulus G* of greater than 0.01 MPa.

5. The tire according to claim 4, wherein the dynamic modulus G* is such that:
0.01<G*<0.1 MPa.

6. The tire according to claim 1, wherein the given temperature range additionally includes the range from +10° C. to +30° C. and thus extends from +10° C. to +100° C.

7. The tire according to claim 1, wherein the given temperature range additionally includes the range from +100° C. to +130° C. and thus extends from +10° C. to +130° C.

8. The tire according to claim 1, wherein the TPS is the predominant elastomer of the self-sealing layer.

9. The tire according to claim 1, wherein the TPS is chosen from the group of stirene/butadiene/stirene (SBS), stirene/isoprene/stirene (SIS), stirene/isoprene/butadiene/stirene (SIBS), stirene/ethylene-butylene/stirene (SEBS), stirene/ethylene-propylene/stirene (SEPS) and stirene/ethylene-ethylene-propylene/stirene (SEEPS) block copolymers and blends of these copolymers.

10. The tire according to claim 1, wherein the self-sealing layer has a minimum thickness of 0.3 mm.

11. The tire according to claim 1, wherein the elongation at break _{B} of the self-sealing layer is greater than 500%.

12. The tire according to claim 1, wherein the stress at break _{B} of the self-sealing layer is greater than 0.2 MPa.

13. The tire according to claim 1, wherein the self-sealing composition includes an extender oil in an amount of between 200 and 700 phe (parts per hundred elastomer by weight).

14. The tire according to claim 1, further comprising an airtight layer having a rubber composition substantially impermeable to the inflation gas and substantially covering the entire inner wall of said tire, in which the self-sealing layer covers, at least partly, the airtight layer on the side facing the internal cavity of the tire.

15. The tire according to claim 1, further comprising an airtight layer having a rubber composition substantially impermeable to the inflation gas and substantially covering the entire inner wall of said tire, in which the self-sealing layer is placed between the airtight layer and the carcass-type reinforcement.

16. The tire according to claim 14, wherein said self-sealing layer is placed at the crown of said tire.

17. The tire according to claim 14, wherein said self-sealing layer extends from one sidewall to the other, at least up to a radial position corresponding to the equators of said tire.

18. The tire according to claim 14, wherein said self-sealing layer extends from one sidewall to the other, at least up to a radial position corresponding approximately to the edge of the rim gutter when the tire is in the fitted position.
